(19) United States
(12) Patent Application Publication
(10) Pub. No.: US 2023/0003136 A1
(43) Pub. Date: Jan. 5, 2023

(54) CERAMIC VARIABLE STATOR VANE BUSHING

(71) Applicant: SAINT-GOBAIN PERFORMANCE PLASTICS CORPORATION, Solon, OH (US)

(72) Inventors: Jean-Marie LEBRUN, Versailles (FR); Arnaud Verger, Paris (FR); Margaux Ningre-Coirier, Suresnes (FR); Nafih Mekhilef, Shrewsbury, MA (US); Eustache Danysz, Avignon (FR); Christian Murphy, Worcester, MA (US)

(21) Appl. No.: 17/810,072

(22) Filed: Jun. 30, 2022

Related U.S. Application Data
(60) Provisional application No. 63/216,948, filed on Jun. 30, 2021.

(51) Int. Cl. F01D 9/04

(52) U.S. Cl. CPC F01D 9/042; F01D 9/041; F05D 2230/10; F05D 2240/12; F05D 2300/5021; F05D 2300/5024; F05D 2300/516; F05D 2300/609; F05D 2260/30

(57) ABSTRACT

Systems and methods include providing a stator vane bushing for a variable stator vane assembly having a movable stator vane and a stator vane housing disposed annularly about the movable stator vane. The bushing includes a flange, a barrel extending from the flange, and a central aperture extending through the flange and the barrel and is disposed in the housing and annularly about the stator vane. The bushing is formed from a ceramic material having a coefficient of thermal expansion (CTE) lower than or equal to a CTE of one or more of a stator vane and a housing of the variable stator vane assembly.

### CROSS-REFERENCE TO RELATED APPLICATION(S)

This application claims priority under 35 U.S.C. § 119(e) to U.S. Provisional Application No. 63/216,948, entitled “CERAMIC VARIABLE STATOR VANE BUSHING,” by Jean-Marie LEBRUN et al., filed Jun. 30, 2021, which is assigned to the current assignee hereof and incorporated herein by reference in its entirety.

### BACKGROUND OF THE INVENTION

Bushings are used in many industrial applications between components of an assembly. The bushings are utilized to maintain alignment and/or control relative movement between components during operation. In some applications, bushings such as those utilized in variable stator vane assemblies in jet engine compressors or gas turbine engines, are often subjected to extreme operating conditions, such as extreme forces, pressures, and/or temperatures. To withstand these extreme operating conditions, these bushings are commonly formed from graphite or other high performance polymeric materials. However, these materials still present considerable temperature limitations. Further, oxidation of these materials can impact the coefficient of friction between components and negatively affect performance and reliability. Accordingly, the industry continues to demand improvements in bushing technology for such applications.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a partial cross-sectional view of an assembly according to an embodiment of the disclosure.

FIG. 2 is a flowchart of a method of forming a bushing according to an embodiment of the disclosure.

FIG. 3 is a graph of linear speed versus wear scar width of different materials used to form a bushing according to an embodiment of the disclosure within an assembly.

FIG. 4 is a graph of linear speed versus coefficient of friction of different materials used to form a bushing according to an embodiment of the disclosure within an assembly.

FIG. 5 is a graph of wear scar width versus coefficient of friction of different materials used to form a bushing according to an embodiment of the disclosure within an assembly.

The use of the same reference symbols in different drawings indicates similar or identical items.

### DETAILED DESCRIPTION

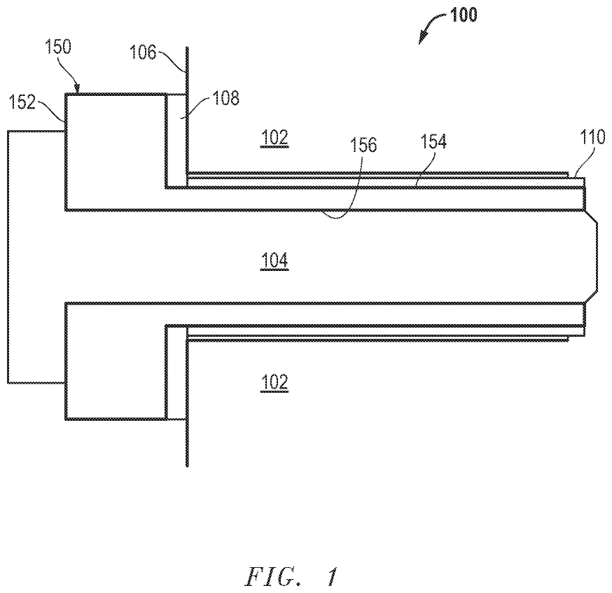

FIG. 1 shows a partial cross-sectional view of an assembly 100 according to an embodiment of the disclosure. In some embodiments, the assembly 100 may be a jet engine compressor or a gas turbine engine. More particularly, in some embodiments, the assembly may be a variable stator vane assembly of a jet engine compressor or a gas turbine engine. The assembly 100 may generally comprise an outer component, such as a stator vane housing 102, and an inner component, such as a movable or rotatable stator vane 104. The housing 102 may generally be disposed annularly about the stator vane 104. Further, in some embodiments, the housing 102 and/or the stator vane 104 may be formed from a metallic material. In some embodiments, the metallic material may comprise steel, stainless steel, titanium, or an alloy thereof.

An annular bushing 150 may generally be at least partially disposed within the housing 102 and annularly about the stator vane 104. The bushing 150 may comprise a flange 152, a barrel 154 extending from the flange 152, and a central aperture 156 extending through the flange 152 and the barrel 154. More specifically, the bushing 150 may be disposed such that the barrel 154 is disposed within the housing 102 and radially between the housing 102 and the stator vane 104, and the flange 152 is disposed adjacent an outer surface 106 of the housing 102. In some embodiments, the flange 152 may substantially abut the outer surface 106 of the housing 102. In some embodiments, a washer 108 may be disposed between the flange 152 and the outer surface 106 of the housing 102. In some embodiments, the barrel 154 may be in contact with the housing 102. In some embodiments, a sleeve 110 may be disposed about the barrel 154 and in contact with the housing 102. In some embodiments, the sleeve 110 may be formed from a metallic material. In some embodiments, the metallic material of the sleeve 110 may substantially match the metallic material of the housing 102 and comprise steel, stainless steel, titanium, or an alloy thereof.

The bushing 150 may generally be configured to maintain alignment between the stator vane 104 and the bushing 150, the housing 102 and the bushing 150, the stator vane 104 and the housing 102, or a combination thereof. In some embodiments, the bushing 150 may be configured to maintain an axial alignment and/or center the stator vane 104 within the housing 102. To prevent temperature restrictions on operation, the bushing 150 may generally be formed from a high temperature resistant material, such as a ceramic material, that allows the bushing 150 to reach higher temperatures without sacrificing application requirements, such as controlling or preventing air leakage, minimizing friction, and minimizing degradation of the bushing 150 under higher temperature friction loads.

Further, the bushing 150 may be designed to have beneficial tolerances between the barrel 154 of the bushing 150 and the housing 102, the stator vane 104, or a combination thereof. In some embodiments, the barrel 154 of the bushing 150 may comprise a substantially zero tolerance with the housing 102, such that the bushing 150 comprises a press-fit installation with the housing 102. In some embodiments, the barrel 154 of the bushing 150 may comprise a minimal tolerance with the housing 102, such that the bushing 150 comprises minimal movement within the housing 102. In some embodiments, the tolerance between the barrel 154 of the bushing 150 and the housing 100 may be at least 0.005%, at least 0.01%, at least 0.02%, at least 0.03%, at least 0.04%, at least 0.05%, at least 0.10%, or at least 0.15% of the diameter of the barrel 154 of the bushing 150. In some embodiments, the tolerance between the barrel 154 of the bushing 150 and the housing 100 may be not greater than 5%, not greater than 4%, not greater than 3%, not greater than 2.5%, not greater than 2%, not greater than 1.5%, not greater than 1%, not greater than 0.75%, not greater than 0.50%, not greater than 0.25%, not greater than 0.20%, not greater than 0.15%, not greater than 0.10%, or not greater than 0.05% of the diameter of the barrel 154 of the bushing 150. Further, it will be appreciated that the tolerance between the barrel 154 of the bushing 150 and the housing 100 may be between any of these minimum and maximum values, such as at least 0.005% to not greater than 5%, or even at least 0.10% to not greater than 0.20%.

In some embodiments, the minimal tolerance between the bushing 150 and the housing 102 and/or a low coefficient of friction (COF) between the bushing 150 and the housing 102 may reduce or minimize local forces applied to the bushing 150 by the stator vane 104 caused by movement of the stator vane 104 within the bushing 150. This reduction or minimization of forces may prevent or substantially reduce bending moments applied to the bushing 150 resulting from radial and/or axial forces caused by operation of the gas turbine engine. Accordingly, the bushing 150 may comprise a longer life span than a traditional graphite or polymeric bushing, while also allowing the bushing 150 to operate at much higher temperatures than traditional graphite or polymeric bushings.

The bushing 150 may generally be formed from a ceramic material. In some embodiments, the bushing 150 may be formed from a ceramic material comprising a CTE equal to or lower than a CTE of the housing 102, the stator vane 104, or a combination thereof. In some embodiments, the bushing 150 may be formed from a ceramic material comprising a CTE that is 0%, at least 1%, at least 2%, at least 3%, at least 4%, at least 5%, at least 6%, at least 7%, at least 8%, at least 9%, at least 10%, or at least 15% lower than the CTE of the housing 102, the stator vane 104, or a combination thereof. In some embodiments, the bushing 150 may be formed from a ceramic material comprising a CTE that is not greater than 30%, not greater than 25%, not greater than 20%, not greater than 15%, not greater than 10%, not greater than 9%, not greater than 8%, not greater than 7%, not greater than 6%, not greater than 5%, not greater than 4%, not greater than 3%, not greater than 2%, or not greater than 1% lower than the CTE of the housing 102, the stator vane 104, or a combination thereof. Further, it will be appreciated that the bushing 150 may be formed from a ceramic material comprising a CTE between any of these minimum and maximum values, such as 0% to not greater than 30%, 0% to not greater than 20%, or even at least 0% to not greater than 10% lower than the CTE of the housing 102, the stator vane 104, or a combination thereof.

In some embodiments, the bushing 150 may be formed from a ceramic material comprising a CTE of at least 0.5 E⁻⁶/K, at least 1.0 E⁻⁶/K, at least 1.5 E⁻⁶/K, at least 2 E⁻⁶/K, at least 3 E⁻⁶/K, at least 4 E⁻⁶/K, at least 5 E⁻⁶/K, at least 6 E⁻⁶/K, at least 7 E⁻⁶/K, at least 8 E⁻⁶/K, at least 9 E⁻⁶/K, at least 10 E⁻⁶/K, at least 11 E⁻⁶/K, at least 12 E⁻⁶/K, or at least 13 E⁻⁶/K. In some embodiments, the bushing 150 may be formed from a ceramic material comprising a CTE of not greater than 14 E⁻⁶/K, not greater than 13 E⁻⁶/K, not greater than 12 E⁻⁶/K, not greater than 11 E⁻⁶/K, or not greater than 10 E⁻⁶/K. Further, it will be appreciated that the bushing 150 may be formed from a ceramic material comprising a CTE between any of these minimum and maximum values, such as at least 0.5 E⁻⁶/K to not greater than 10 E⁻⁶/K, at least 1.5 E⁻⁶/K to not greater than 10 E⁻⁶/K, or even at least 3 E⁻⁶/K to not greater than 12 E⁻⁶/K.

In some embodiments, the bushing 150 may be formed from a ceramic material comprising a flexural strength of at least 25 MPa, at least 50 MPa, at least 75 MPa, at least 100 MPa, at least 200 MPa, at least 300 MPa, at least 400 MPa, at least 500 MPa, at least 750 MPa, or at least 1000 MPa. In some embodiments, the bushing 150 may be formed from a ceramic material comprising a flexural strength of not greater than 1500 MPa, not greater than 1250 MPa, not greater than 1000 MPa, not greater than 750 MPa, not greater than 500 MPa, not greater than 400 MPa, not greater than 300 MPa, not greater than 200 MPa, or not greater than 100 MPa. Further, it will be appreciated that the bushing 150 may be formed from a ceramic material comprising a flexural strength between any of these minimum and maximum values, such as at least 25 MPa to not greater than 1500 MPa, at least 25 MPa to not greater than 500 MPa, or even at least 25 MPa to not greater than 100 MPa.

In some embodiments, the bushing 150 may have a thermal conductivity of at least 2 W/mK. The bushing 150 may have a thermal conductivity of not greater than 30 W/mK. Further it will be appreciated that the bushing 150 may have a thermal conductivity between any of these minimum and maximum values.

In some embodiments, the bushing 150 may be formed from a ceramic material having a surface with an Ra surface roughness value of not greater than 0.4 μm, not greater than 0.3 μm, not greater than 0.2 μm, not greater than 0.1 μm, not greater than 0.01 μm, or not greater than 0.005 μm. Further it will be appreciated that the bushing 150 may have a surface roughness between any of these minimum and maximum values.

In some embodiments, the bushing 150 may be formed from a ceramic material comprising a hardness of at least 1 kilogram per square millimeter (kg/mm²), at least 2 kg/mm², at least 3 kg/mm², at least 4 kg/mm², at least 5 kg/mm², at least 10 kg/mm², at least 15 kg/mm², at least 20 kg/mm², at least 25 kg/mm², at least 50 kg/mm², at least 100 kg/mm², at least 200 kg/mm², at least 300 kg/mm², at least 400 kg/mm², at least 500 kg/mm², or at least 1000 kg/mm². In some embodiments, the bushing 150 may be formed from a ceramic material comprising a hardness of not greater than 2000 kg/mm², not greater than 1750 kg/mm², not greater than 1500 kg/mm², not greater than 1250 kg/mm², not greater than 1000 kg/mm², not greater than 750 kg/mm², not greater than 500 kg/mm², not greater than 400 kg/mm², not greater than 300 kg/mm², not greater than 200 kg/mm², not greater than 100 kg/mm², not greater than 50 kg/mm², or not greater than 25 kg/mm². Further, it will be appreciated that the bushing 150 may be formed from a ceramic material comprising a hardness between any of these minimum and maximum values, such as at least 1 kg/mm² to not greater than 2000 kg/mm², at least 2 kg/mm² to not greater than 1000 kg/mm², or even at least 3 kg/mm² to not greater than 15 kg/mm².

In some embodiments, the bushing 150 may have a grain size of ceramic material particles of at least 0.5 at least 1 at least 10 μm, or even at least 25 μm. The bushing 150 may have a grain size of ceramic material particles of not greater than 10 μm, not greater than 5 μm, not greater than 1 μm, or even not greater than 0.5 μm. Further it will be appreciated that the bushing 150 may have a grain size of ceramic material particles between any of these minimum and maximum values.

In some embodiments, the bushing 150 may be formed from a ceramic material comprising at least one metallic element comprising aluminum, boron, copper, zircon, chromium, silicon, titanium, hafnium, tungsten, tantalum, yttrium, or a combination thereof. In some embodiments, the bushing 150 may be formed from a ceramic material comprising at least one metallic element comprising aluminum, boron, copper, zircon, chromium, silicon, titanium, hafnium, tungsten, tantalum, yttrium, or a combination thereof, and combined with carbon, oxygen, or nitrogen, or a combination thereof. In some embodiments, the bushing 150 may be formed from a ceramic material comprising aluminum oxide, aluminum nitride, boron nitride, copper oxide, silicon nitride, silicon oxide, zirconium oxide, zirconium dioxide, or a combination thereof. In some embodiments, the bushing 150 may be formed from a ceramic material comprising a boron nitride composite material (hBN). In some embodiments, the bushing 150 may be formed from a ceramic material consisting essentially of a boron nitride composite material (hBN). In some embodiments, the boron nitride composite material (hBN) may comprise grade ZSBN boron nitride. In some embodiments, the boron nitride composite material (hBN) may comprise boron nitride (BN), zirconium dioxide (ZrO₂), and borosilicate glass (BOD). In some embodiments, the boron nitride composite material (hBN) may comprise about 45 wt. % boron nitride (BN), about 45% zirconium dioxide (ZrO₂), and about 10 wt. % of borosilicate glass as a crystalline phase.

In some embodiments, the bushing 150 may be formed from a ceramic material comprising one or more anisotropic thermomechanical properties. In some embodiments, the one or more anisotropic thermomechanical properties may comprise the CTE of the ceramic material of the bushing. In some embodiments, the CTE of the ceramic material of the bushing 150 may be measured at a first temperature between 0 degrees Celsius and 500 degrees Celsius along a first direction is at least 5%, at least 10%, at least 15%, at least 20%, at least 25%, at least 30%, at least 35%, at least 40%, at least 45%, or at least 50% lower or higher than the CTE of the ceramic material of the bushing 150 as measured at the same temperature in a second direction that is orthogonal to the first direction. In some embodiments, the CTE of the ceramic material of the bushing 150 as measured in a radial direction as compared to the CTE of the ceramic material of the bushing 150 as measured in a longitudinal direction is closest to the CTE of the stator vane 104, the housing 102, or a combination thereof. In some embodiments, the CTE of the ceramic material of the bushing as measured in the radial direction may be anisotropic. In some embodiments, the CTE of the ceramic material of the bushing as measured in the radial direction may be isotropic.

The minimal tolerance between the bushing 150 and the housing 102 and/or a low coefficient of friction (COF) between the bushing 150 and the housing 102 may reduce or minimize local forces applied to the bushing 150 by the stator vane 104 caused by movement of the stator vane 104 within the bushing 150. This reduction or minimization of forces may prevent or substantially reduce bending moments applied to the bushing 150 resulting from radial and/or axial forces caused by operation of the gas turbine engine. Thus, in some embodiments, the bushing 150 may be formed from a ceramic material comprising a coefficient of friction (COF) with the housing 102 of not greater than 1.0, not greater than 0.9, not greater than 0.8, not greater than 0.7, not greater than 0.6, not greater than 0.6, not greater than 0.5, not greater than 0.4, not greater than 0.3, or not greater than 0.2.

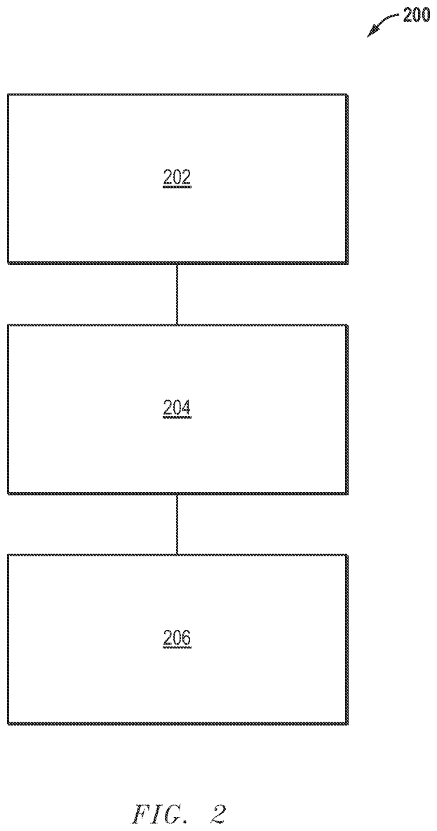

Further, this reduction or minimization of forces may prevent or substantially reduce bending moments applied to the bushing 150 resulting from radial and/or axial forces caused by operation of the gas turbine engine. Accordingly, the bushing 150 may comprise a longer life span than traditional graphite or polymeric bushings, while also allowing the bushing 150 to operate at much higher temperatures than traditional graphite or polymeric bushings. Thus, in some embodiments, the bushing 150 may be configured to withstand operating temperatures of at least 500 degrees Celsius, at least 600 degrees Celsius, at least 700 degrees Celsius, at least 800 degrees Celsius, at least 850 degrees Celsius, at least 900 degrees Celsius, at least 950 degrees Celsius, at least 1000 degrees Celsius, or even higher under air (e.g., airflow). Operation at these temperatures may be at standard atmospheric pressure up to a pressure of at least 10 bar, at least 20 bar, at least 30 bar, at least 40 bar, at least 50 bar, or even as high as at least 60 bar. FIG. 2 shows a flowchart of a method 200 of forming a variable stator vane bushing 150 according to an embodiment of the disclosure. The method 200 may begin at block 202 by providing a bulk material comprising a ceramic material. In some embodiments, the bulk material may comprise an anisotropic ceramic material. The method 200 may continue at block 204 by orienting the bulk material. In some embodiments, orienting the bulk material ensures the bushing 150 comprises a CTE of at least 0.5 E⁻⁶/K as measured in at least one of an axial direction and a radial direction. The method 200 may continue at block 206 by machining the bulk material to form a bushing 150 comprising a flange 152, a barrel 154 extending from the flange 152, and a central aperture 156 extending through the flange 152 and the barrel 154, wherein the bushing 150 comprises a coefficient of thermal expansion (CTE) of at least 0.5 E⁻⁶/K in at least one of the axial direction and the radial direction.

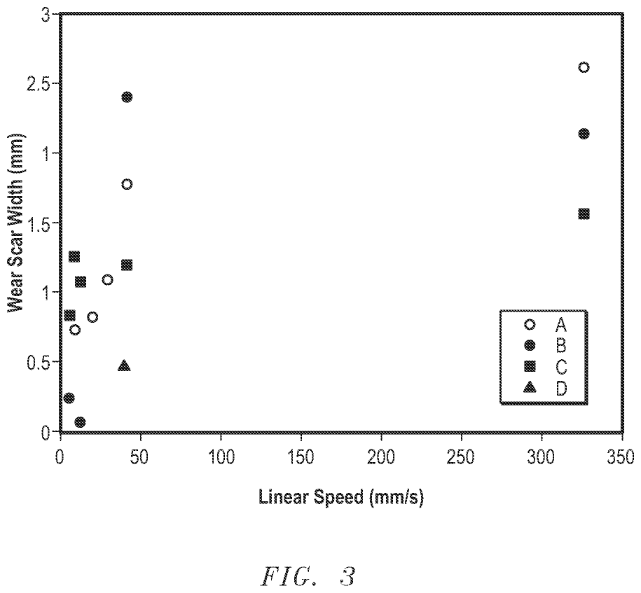

FIG. 3 shows a graph of linear speed versus wear scar width of different materials used to form a bushing according to an embodiment of the disclosure within an assembly. Dots labeled A showcases a zirconia-based ceramic material. Dots labeled B showcase a zirconium silicate-based ceramic material. Dots labeled C showcase a graphite-based ceramic material. Dots labeled D showcases a zirconia-based ceramic material with a polished surface. The bushing according to embodiments herein included the designated ceramic material and was rotated within an assembly at a linear speed of 5.5 mm/s and 300 mm/s. The linear speed is a product of oscillating frequency and a travel distance. The oscillating frequency may be between 0.5 Hz and 500 Hz. The travel distance may be between 0.1 mm and 5 mm. As shown, the choice of ceramic material on the bushing shows improved wear performance versus existing bushings.

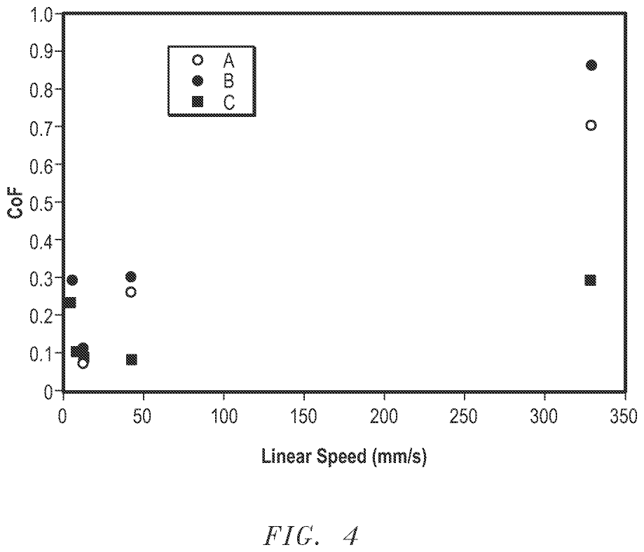

FIG. 4 shows a graph of linear speed versus coefficient of friction of different materials used to form a bushing according to an embodiment of the disclosure within an assembly. Dots labeled A showcases a zirconia-based ceramic material. Dots labeled B showcase a zirconium silicate-based ceramic material. Dots labeled C showcase a graphite-based ceramic material. The bushing according to embodiments herein included the designated ceramic material and was rotated within an assembly at a linear speed of 5.5 mm/s and 300 mm/s. The linear speed is a product of oscillating frequency and a travel distance. The oscillating frequency may be between 0.5 Hz and 500 Hz. The travel distance may be between 0.1 mm and 5 mm. As shown, the choice of ceramic material on the bushing shows improved coefficient of friction versus existing bushings.

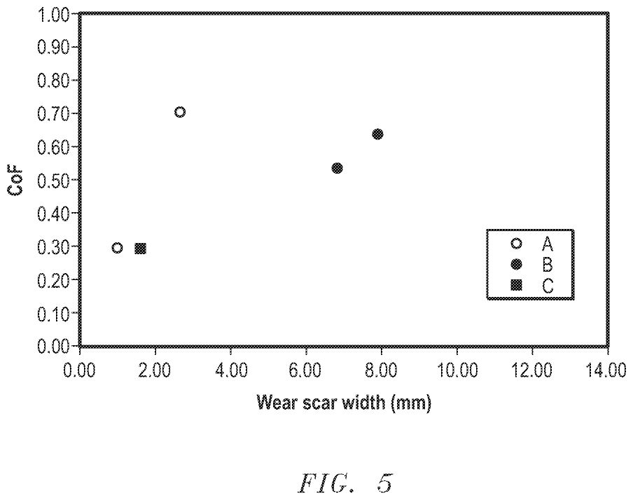

FIG. 5 shows a graph of wear scar width versus coefficient of friction of different materials used to form a bushing according to an embodiment of the disclosure within an assembly. Dots labeled A showcases a zirconia-based ceramic material. Dots labeled B showcase a zirconium silicate-based ceramic material. Dots labeled C showcase a graphite-based ceramic material. The bushing according to embodiments herein included the designated ceramic material and was rotated within an assembly at a linear speed of 5.5 mm/s and 300 mm/s. The linear speed is a product of oscillating frequency and a travel distance. The oscillating frequency may be between 0.5 Hz and 500 Hz. The travel distance may be between 0.1 mm and 5 mm. As shown, the choice of ceramic material on the bushing shows improved wear performance and coefficient of friction versus existing bushings.

Embodiments of an assembly 100, a bushing 150, and/or a method 200 of forming a variable stator bushing 150 may include one or more of the following embodiments:

Embodiment 1. A variable stator vane bushing, comprising: a flange, a barrel extending from the flange, and a central aperture extending through the flange and the barrel, wherein the bushing is formed from a ceramic material comprising a coefficient of thermal expansion (CTE) of at least 0.5 E⁻⁶/K.

Embodiment 2. The bushing of embodiment 1, wherein the bushing is suitable for use in a variable stator vane assembly comprising a movable or rotatable stator vane and a stator vane housing disposed annularly about the movable stator vane, wherein the bushing is at least partially disposed in the housing and annularly about the stator vane.

Embodiment 3. A variable stator vane assembly, comprising: a movable or rotatable stator vane; a stator vane housing disposed annularly about the stator vane; and a bushing at least partially disposed in the housing and annularly about the stator vane, wherein the bushing comprises a flange, a barrel extending from the flange, and a central aperture extending through the flange and the barrel, wherein the bushing is formed from a ceramic material comprising a coefficient of thermal expansion (CTE) of at least 0.5 E⁻⁶/K.

Embodiment 4. The bushing or the assembly of any one of embodiments 2 to 3, wherein the housing is formed from stainless steel, titanium, or an alloy thereof.

Embodiment 5. The bushing or the assembly of any one of embodiments 2 to 4, wherein the bushing is formed from a ceramic material comprising a CTE lower than or equal to a CTE of the stator vane, the housing, or a combination thereof.

Embodiment 6. The bushing or the assembly of any one of embodiments 2 to 5, wherein the bushing is formed from a ceramic material comprising a CTE that is 0%, at least 1%, at least 2%, at least 3%, at least 4%, at least 5%, at least 6%, at least 7%, at least 8%, at least 9%, at least 10%, or at least 15% lower than the CTE of the stator vane, the housing, or a combination thereof.

Embodiment 7. The bushing or the assembly of any one of embodiments 2 to 6, wherein the bushing is formed from a ceramic material comprising a CTE that is not greater than 30%, not greater than 25%, not greater than 20%, not greater than 15%, not greater than 10%, not greater than 9%, not greater than 8%, not greater than 7%, not greater than 6%, not greater than 5%, not greater than 4%, not greater than 3%, not greater than 2%, or not greater than 1% lower than the CTE of the stator vane, the housing, or a combination thereof.

Embodiment 8. The bushing or the assembly of any one of embodiments 1 to 7, wherein the bushing is formed from a ceramic material comprising a CTE of at least 0.5 E⁻⁶/K, at least 1.0 E⁻⁶/K, at least 1.5 E⁻⁶/K, at least 2 E⁻⁶/K, at least 3 E⁻⁶/K, at least 4 E⁻⁶/K, at least 5 E⁻⁶/K, at least 6 E⁻⁶/K, at least 7 E⁻⁶/K, at least 8 E⁻⁶/K, at least 9 E⁻⁶/K, at least 10 E⁻⁶/K, at least 11 E⁻⁶/K, at least 12 E⁻⁶/K, or at least 13 E⁻⁶/K.

Embodiment 9. The bushing or the assembly of any one of embodiments 1 to 8, wherein the bushing is formed from a ceramic material comprising a CTE of not greater than 14 E⁻⁶/K, not greater than 13 E⁻⁶/K, not greater than 12 E⁻⁶/K, not greater than 11 E⁻⁶/K, or not greater than 10 E⁻⁶/K.

Embodiment 10. The bushing or the assembly of any one of embodiments 1 to 9, wherein the bushing is formed from a ceramic material comprising a flexural strength of at least 25 MPa, at least 50 MPa, at least 75 MPa, at least 100 MPa, at least 200 MPa, at least 300 MPa, at least 400 MPa, at least 500 MPa, at least 750 MPa, or at least 1000 MPa.

Embodiment 11. The bushing or the assembly of any one of embodiments 1 to 10, wherein the bushing is formed from a ceramic material comprising a flexural strength of not greater than 1500 MPa, not greater than 1250 MPa, not greater than 1000 MPa, not greater than 750 MPa, not greater than 500 MPa, not greater than 400 MPa, not greater than 300 MPa, not greater than 200 MPa, or not greater than 100 MPa.

Embodiment 12. The bushing or the assembly of any one of embodiments 1 to 11, wherein the bushing is formed from a ceramic material comprising a hardness of at least 1 kilogram per square millimeter (kg/mm²), at least 2 kg/mm², at least 3 kg/mm², at least 4 kg/mm², at least 5 kg/mm², at least 10 kg/mm², at least 15 kg/mm², at least 20 kg/mm², at least 25 kg/mm², at least 50 kg/mm², at least 100 kg/mm², at least 200 kg/mm², at least 300 kg/mm², at least 400 kg/mm², at least 500 kg/mm², or at least 1000 kg/mm².

Embodiment 13. The bushing or the assembly of any one of embodiments 1 to 12, wherein the bushing is formed from a ceramic material comprising a hardness of not greater than 2000 kg/mm², not greater than 1750 kg/mm², not greater than 1500 kg/mm², not greater than 1250 kg/mm², not greater than 1000 kg/mm², not greater than 750 kg/mm², not greater than 500 kg/mm², not greater than 400 kg/mm², not greater than 300 kg/mm², not greater than 200 kg/mm², not greater than 100 kg/mm², not greater than 50 kg/mm², or not greater than 25 kg/mm².

Embodiment 14. The bushing or the assembly of any one of embodiments 1 to 13, wherein the bushing is formed from a ceramic material comprising a coefficient of friction (COF) with the housing of not greater than 1.0, not greater than 0.9, not greater than 0.8, not greater than 0.7, not greater than 0.6, not greater than 0.6, not greater than 0.5, not greater than 0.4, not greater than 0.3, or not greater than 0.2.

Embodiment 15. The bushing or the assembly of any one of embodiments 1 to 14, wherein the bushing is formed from a ceramic material comprising at least one metallic element comprising aluminum, boron, copper, zircon, chromium, silicon, titanium, hafnium, tungsten, tantalum, yttrium, or a combination thereof, combined with carbon, oxygen, or nitrogen, or a combination thereof.

Embodiment 16. The bushing or the assembly of embodiment 15, wherein the bushing is formed from a ceramic material comprising one or more anisotropic thermomechanical properties.

Embodiment 17. The bushing or the assembly of any one of embodiments 15 to 16, wherein the one or more anisotropic thermomechanical properties comprises the CTE of the ceramic material of the bushing, and wherein the CTE of the ceramic material of the bushing is measured at a first temperature between 0 degrees Celsius and 500 degrees Celsius along a first direction is at least 5%, at least 10%, at least 15%, at least 20%, at least 25%, at least 30%, at least 35%, at least 40%, at least 45%, or at least 50% lower or higher than the CTE of the ceramic material of the bushing as measured at the same temperature in a second direction that is orthogonal to the first direction.

Embodiment 18. The bushing or the assembly of any one of embodiments 15 to 17, wherein the CTE of the ceramic material of the bushing as measured in a radial direction as compared to the CTE of the ceramic material of the bushing as measured in a longitudinal direction is closest to the CTE of the stator vane, the housing, or a combination thereof.

Embodiment 19. The bushing or the assembly of embodiment 18, wherein the CTE of the ceramic material of the bushing as measured in the radial direction is anisotropic.

Embodiment 20. The bushing or the assembly of embodiment 18, the CTE of the ceramic material of the bushing as measured in the radial direction is isotropic.

Embodiment 21. The bushing or the assembly of any one of embodiments 15 to 20, wherein the bushing is formed from a ceramic material comprising aluminum oxide, aluminum nitride, boron nitride, copper oxide, silicon nitride, silicon oxide, zirconium oxide, or a combination thereof.

Embodiment 22. The bushing or the assembly of any one of embodiments 15 to 20, wherein the bushing is formed from a ceramic material comprising a boron nitride composite material (hBN).

Embodiment 23. The bushing or the assembly of any one of embodiments 2 to 22, wherein the flange of the bushing substantially abuts the housing.

Embodiment 24. The bushing or the assembly of any one of embodiments 2 to 22, further comprising: a washer disposed between the flange of the bushing and the housing.

Embodiment 25. The bushing or the assembly of any one of embodiments 1 to 24, further comprising: a sleeve disposed about the barrel of the bushing.

Embodiment 26. The bushing or the assembly of embodiment 25, wherein the sleeve comprising steel, stainless steel, titanium, or an alloy thereof.

Embodiment 27. The bushing or the assembly of any one of embodiments 2 to 26, wherein the tolerance between the barrel of the bushing and the housing is 0%, at least 0.005%, at least 0.01%, at least 0.02%, at least 0.03%, at least 0.04%, at least 0.05%, at least 0.10%, or at least 0.15% of the diameter of the barrel of the bushing.

Embodiment 28. The bushing or the assembly of any one of embodiments 2 to 27, wherein the tolerance between the barrel of the bushing and the housing is not greater than 5%, not greater than 4%, not greater than 3%, not greater than 2.5%, not greater than 2%, not greater than 1.5%, not greater than 1%, not greater than 0.75%, not greater than 0.50%, not greater than 0.25%, not greater than 0.20%, not greater than 0.15%, not greater than 0.10%, or not greater than 0.05% of the diameter of the barrel of the bushing.

Embodiment 29. The bushing or the assembly of any one of embodiments 1 to 28, wherein the bushing is configured to withstand operating temperatures of at least 500 degrees Celsius, at least 600 degrees Celsius, at least 700 degrees Celsius, at least 800 degrees Celsius, at least 850 degrees Celsius, at least 900 degrees Celsius, at least 950 degrees Celsius, or at least 1000 degrees Celsius under air.

Embodiment 30. A method of forming a variable stator vane bushing, comprising: providing a bulk material comprising a ceramic material; orienting the bulk material; and machining the bulk material to form a bushing comprising a flange, a barrel extending from the flange, and a central aperture extending through the flange and the barrel, wherein the bushing comprises a coefficient of thermal expansion (CTE) of at least 0.5 E⁻⁶/K.

Embodiment 31. The method of embodiment 30, wherein the bushing is formed from a ceramic material comprising a CTE of at least 0.5 E⁻⁶/K, at least 1.0 E⁻⁶/K, at least 1.5 E⁻⁶/K, at least 2 E⁻⁶/K, at least 3 E⁻⁶/K, at least 4 E⁻⁶/K, at least 5 E⁻⁶/K, at least 6 E⁻⁶/K, at least 7 E⁻⁶/K, at least 8 E⁻⁶/K, at least 9 E⁻⁶/K, at least 10 E⁻⁶/K, at least 11 E⁻⁶/K, at least 12 E⁻⁶/K, or at least 13 E⁻⁶/K.

Embodiment 32. The method of any one of embodiments 30 to 31, wherein the bushing is formed from a ceramic material comprising a CTE of not greater than 14 E⁻⁶/K, not greater than 13 E⁻⁶/K, not greater than 12 E⁻⁶/K, not greater than 11 E⁻⁶/K, or not greater than 10 E⁻⁶/K.

Embodiment 33. The method of any one of embodiments 30 to 32, wherein the bushing is formed from a ceramic material comprising a flexural strength of at least 25 MPa, at least 50 MPa, at least 75 MPa, at least 100 MPa, at least 200 MPa, at least 300 MPa, at least 400 MPa, at least 500 MPa, at least 750 MPa, or at least 1000 MPa.

Embodiment 34. The method of any one of embodiments 30 to 33, wherein the bushing is formed from a ceramic material comprising a flexural strength of not greater than 1500 MPa, not greater than 1250 MPa, not greater than 1000 MPa, not greater than 750 MPa, not greater than 500 MPa, not greater than 400 MPa, not greater than 300 MPa, not greater than 200 MPa, or not greater than 100 MPa.

Embodiment 35. The method of any one of embodiments 30 to 34, wherein the bushing is formed from a ceramic material comprising a hardness of at least 1 kilogram per square millimeter (kg/mm²), at least 2 kg/mm², at least 3 kg/mm², at least 4 kg/mm², at least 5 kg/mm², at least 10 kg/mm², at least 15 kg/mm², at least 20 kg/mm², at least 25 kg/mm², at least 50 kg/mm², at least 100 kg/mm², at least 200 kg/mm², at least 300 kg/mm², at least 400 kg/mm², at least 500 kg/mm², or at least 1000 kg/mm².

Embodiment 36. The method of any one of embodiments 30 to 35, wherein the bushing is formed from a ceramic material comprising a hardness of not greater than 2000 kg/mm², not greater than 1750 kg/mm², not greater than 1500 kg/mm², not greater than 1250 kg/mm², not greater than 1000 kg/mm², not greater than 750 kg/mm², not greater than 500 kg/mm², not greater than 400 kg/mm², not greater than 300 kg/mm², not greater than 200 kg/mm², not greater than 100 kg/mm², not greater than 50 kg/mm², or not greater than 25 kg/mm².

Embodiment 37. The method of any one of embodiments 30 to 36, wherein the bushing is formed from a ceramic material comprising at least one metallic element comprising aluminum, boron, copper, zircon, chromium, silicon, titanium, hafnium, tungsten, tantalum, yttrium, or a combination thereof, combined with carbon, oxygen, or nitrogen, or a combination thereof.

Embodiment 38. The method of embodiment 37, wherein the bushing is formed from a ceramic material comprising anisotropic thermomechanical properties.

Embodiment 39. The method of any one of embodiments 37 to 38, wherein the CTE of the ceramic material is measured at a first temperature between 0 degrees Celsius and 500 degrees Celsius along a first direction is at least 5%, at least 10%, at least 15%, at least 20%, at least 25%, at least 30%, at least 35%, at least 40%, at least 45%, or at least 50% lower or higher than the CTE measured at the same temperature in a second direction that is orthogonal to the first direction.

Embodiment 40. The method of any one of embodiments 37 to 39, wherein the CTE of the bushing in a radial direction as compared to the CTE of the bushing in a longitudinal direction is closest to the CTE of the stator vane, the housing, or a combination thereof.

Embodiment 41. The method of embodiment 40, wherein the CTE in the radial direction of the bushing is anisotropic.

Embodiment 42. The method of embodiment 40, wherein the bushing comprises a CTE in the radial direction that is isotropic.

Embodiment 43. The method of any one of embodiments 37 to 42, wherein the bushing is formed from a ceramic material comprising aluminum oxide, aluminum nitride, boron nitride, copper oxide, silicon nitride, silicon oxide, zirconium oxide, zirconium dioxide, or a combination thereof.

Embodiment 44. The method of any one of embodiments 37 to 42, wherein the bushing is formed from a ceramic material comprising a boron nitride composite material (hBN).

Embodiment 45. The method of any one of embodiments 30 to 44, wherein orienting the bulk material ensures the bushing comprises a CTE of at least 0.5 E⁻⁶/K as measured in at least one of the radial direction and the longitudinal direction.

Embodiment 46. The method of any one of embodiments 30 to 45, wherein the bushing is configured to withstand operating temperatures of at least 500 degrees Celsius, at least 600 degrees Celsius, at least 700 degrees Celsius, at least 800 degrees Celsius, at least 850 degrees Celsius, at least 900 degrees Celsius, at least 950 degrees Celsius, or at least 1000 degrees Celsius under air.

Embodiment 47. The assembly of embodiment 3, wherein the bushing rotates and vibrates within stator vane housing with a linear speed of at least 5 mm/s.

Embodiment 48. The assembly of embodiment 47, wherein the linear speed is a product of an oscillating frequency and a travel distance.

Embodiment 49. The assembly of embodiment 48, wherein the oscillating frequency is between 0.5 Hz and 500 Hz.

Embodiment 50. The assembly of embodiment 48, wherein the travel distance is between 0.1 mm and 5 mm.

Embodiment 51. The bushing, assembly, or method of any one of embodiments 1 to 50, wherein the ceramic material has a grain size lower than 10 μm.

Embodiment 52. The bushing, assembly, or method of any one of embodiments 1 to 50, wherein the ceramic material has a grain size lower than 5 μm.

Embodiment 53. The bushing, assembly, or method of any one of embodiments 1 to 50, wherein the ceramic material has a grain size lower than 1 μm.

Embodiment 54. The bushing, assembly, or method of any one of embodiments 1 to 50, wherein the ceramic material has a grain size lower than 0.5 μm.

Embodiment 55. The bushing, assembly, or method of any one of embodiments 1 to 54, wherein the ceramic material has a thermal conductivity of at least 2 W/m K, at least 5 W/m K, at least 10 W/m K, at least 20 W/m K.

Embodiment 56. The bushing, assembly, or method of any one of embodiments 1 to 55, wherein the bushing is formed from a ceramic material comprising a surface with an Ra surface roughness value of not greater than 0.4 μm, not greater than 0.3 μm, not greater than 0.2 inn, not greater than 0.1 inn, not greater than 0.01 μm, or not greater than 0.005 μm.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A variable stator vane bushing, comprising:
a flange, a barrel extending from the flange, and a central aperture extending through the flange and the barrel, wherein the bushing is formed from a ceramic material comprising a coefficient of thermal expansion (CTE) of at least 0.5 E⁻⁶/K.

2. The bushing of claim 1, wherein the bushing is suitable for use in a variable stator vane assembly comprising a movable or rotatable stator vane and a stator vane housing disposed annularly about the movable stator vane, wherein the bushing is at least partially disposed in the housing and annularly about the stator vane.

3. A variable stator vane assembly, comprising:
a movable or rotatable stator vane;
a stator vane housing disposed annularly about the stator vane; and
a bushing at least partially disposed in the housing and annularly about the stator vane, wherein the bushing comprises a flange, a barrel extending from the flange, and a central aperture extending through the flange and the barrel, wherein the bushing is formed from a ceramic material comprising a coefficient of thermal expansion (CTE) of at least 0.5 E⁻⁶/K.

4. The assembly of claim 3, wherein the housing is formed from stainless steel, titanium, or an alloy thereof.

5. The bushing of claim 2, wherein the bushing is formed from a ceramic material comprising a CTE lower than or equal to a CTE of the stator vane, the housing, or a combination thereof.

6. The bushing of claim 1, wherein the bushing is formed from a ceramic material comprising a coefficient of friction (COF) with the housing of not greater than 1.0.

7. The bushing of claim 1, wherein the bushing is formed from a ceramic material comprising at least one metallic element comprising aluminum, boron, copper, zircon, chromium, silicon, titanium, hafnium, tungsten, tantalum, yttrium, or a combination thereof, combined with carbon, oxygen, or nitrogen, or a combination thereof.

8. The bushing of claim 7, wherein the CTE of the ceramic material of the bushing as measured in a radial direction as compared to the CTE of the ceramic material of the bushing as measured in a longitudinal direction is closest to the CTE of the stator vane, the housing, or a combination thereof.

9. The bushing of claim 7, wherein the bushing is formed from a ceramic material comprising aluminum oxide, aluminum nitride, boron nitride, copper oxide, silicon nitride, silicon oxide, zirconium oxide, or a combination thereof.

10. The assembly of claim 3, wherein the flange of the bushing substantially abuts the housing.

11. The assembly of claim 3, further comprising: a washer disposed between the flange of the bushing and the housing.

12. The assembly of claim 3, further comprising: a sleeve disposed about the barrel of the bushing.

13. A method of forming a variable stator vane bushing, comprising:
providing a bulk material comprising a ceramic material;
orienting the bulk material; and
machining the bulk material to form a bushing comprising a flange, a barrel extending from the flange, and a central aperture extending through the flange and the barrel, wherein the bushing comprises a coefficient of thermal expansion (CTE) of at least 0.5 E⁻⁶/K.

14. The assembly of claim 3, wherein the bushing rotates and vibrates within stator vane housing with a linear speed of at least 5 mm/s.

15. The assembly of claim 14, wherein the oscillating frequency is between 0.5 Hz and 500 Hz.

16. The assembly of claim 14, wherein the linear speed is a product of an oscillating frequency and a travel distance, and wherein the travel distance is between 0.1 mm and 5 mm.

17. The bushing of claim 1, wherein the ceramic material has a grain size lower than 10 μm.

18. The bushing of claim 1, wherein the ceramic material has a thermal conductivity of at least 2 W/mK.

19. The bushing of claim 1, wherein the bushing is formed from a ceramic material comprising a CTE of at least 0.5 E⁻⁶/K and not greater than 14 E⁻⁶/K.

20. The bushing of claim 1, wherein the bushing is formed from a ceramic material comprising a surface with an Ra surface roughness value of not greater than 0.4 μm.
